(19) United States
(12) Patent Application Publication
(10) Pub. No.: US 2002/0162747 A1
(43) Pub. Date: Nov. 7, 2002

(54) Method and device for regulating and optimizing transport of humidity by means of electroosmosis

(76) Inventor: Kjell Utklev, Kjellerod (NO)

Correspondence Address: CHARLES N.J. RUGGIERO, ESQ., OHLANDT, GREELEY, RUGGIERO & PERLE, L.L.P., 10th FLOOR, ONE LANDMARK SQUARE, STAMFORD, CT, 06901-2682, US

(21) Appl. No.: 10/051,515

(22) Filed: Jan. 17, 2002

Related U.S. Application Data
(63) Continuation of application No. 09/643,101, filed on Aug. 21, 2000, now abandoned.
Application No. 09/643,101 is a continuation of application No. 08/983,377, filed on Sep. 9, 1998, now Pat. No. 6,126,802.
Application No. 08/983,377 is a continuation of application No. 09/080,440, filed on May 18, 1998, now Pat. No. 6,388,710.
Application No. 09/080,440 is a continuation of application No. 09/008,096, filed on Jan. 16, 1998, now abandoned.

(30) Foreign Application Priority Data
Jul. 19, 1995 (NO) 952874
Jul. 19, 1996 (NO) PCT/NO96/00189

(51) Int. Cl. B01D 61/56

(52) U.S. Cl. 204/515; 204/600; 204/648

(57) ABSTRACT

In a method for regulating and optimizing transport of liquid in a porous structure by means of electroosmosis, a pulse pattern applied to one or more electrode pairs which are used during the electroosmosis is regulated by detecting a potential difference ΔVₚ over the electrode pair or electrode pairs during the duration t₃ of a neutral pulse which forms part of the pulse pattern and subsequently regulating either the duration t₃ of the neutral pulse or the duration Tₚ of the pulse pattern or both on the basis of the detected potential difference ΔVₚ and any change therein from measuring cycle to measuring cycle. A device for implementing the method comprises a power source with a pulse generator which supplies the desired pulse patterns to one or more electrode pairs (A, K) with the anode (A) provided in the porous structure and the cathode (K) in earth respectively, a voltage detector connected in series via each electrode pair (A, K) and a program control unit in a loop between the voltage detector and the power source's pulse generator.

The present invention concerns a method for regulating and optimizing transport of liquid in porous structures by means of electroosmosis, according to the introduction to claim 1. The invention also concerns a device for implementing the method.

In Swedish patent publication No. 450 264 a method is disclosed for the removal of humidity in a brick wall by means of electroosmosis. An alternating voltage with a positive mean value is fed to electrodes in a concrete or masonry structure and to an earth electrode. The positive pulse is 2-20 times longer than the negative pulse, which must be at least 20 ms. According to this publication a similar method is also employed for introducing a hydrophobic liquid into the structure, again by means of an alternating voltage of the same type as that used in the removal of humidity, but now a positive pulse of 1 s. and a negative pulse of 200 ms are used, while between the negative pulse and the subsequent positive pulse a neutral interval of 200 ms is employed.

When using electroosmosis for transport of liquids in porous media, especially for the expulsion of humidity from masonry, there is a problem that the process comes to a stop due to the build-up of a potential on the electrodes. In order to maintain the process until the relative humidity in the structure has dropped to a level where electroosmotic transport processes will no longer occur, the electrodes therefore have to be depolarized. According to the above-mentioned Swedish patent publication this takes place during the negative pulse.

It has been shown, however, that it is not possible to reduce the relative humidity by this means to a level where ionic transport phenomena entirely cease, which is one of the main objects of the removal of humidity by means of electroosmosis.

In U.S. Pat. No. 5,368,709 a method is disclosed for removing or controlling humidity in concrete or masonry structures by means of electroosmosis, where a pulse voltage is employed with a pulse pattern consisting of a positive pulse followed by a negative pulse of substantially shorter duration than the positive pulse and subsequently a neutral pulse whose duration can initially be much shorter than, e.g., the duration of the negative pulse. By increasing the duration of the neutral pulse in the course of the process and possibly also the duration of the pulse pattern, it will be possible to achieve an approximately complete depolarization of the electrodes, with the result that the electroosmotic process is maintained until the relative humidity in the structure has dropped to a level where the ionic transport phenomena in the liquid and thereby the electroosmosis entirely cease. The electrodes are then fed with a pulse voltage, where the pulse pattern has a form and duration which substantially correspond to those it had when the electroosmotic process stopped.

With this method, however, there is a problem that the pulse pattern and the adjustment thereof are performed without direct reference to the actual polarization state of the electrodes and mainly on an empirical or heuristic basis, with the result that the electroosmotic process is not optimal, even though the final result will generally be good.

Thus it is an object of the present invention to provide a method which permits regulation and optimization of transport of liquids in porous structures by means of electroosmosis in general and not only by expelling humidity from, e.g., concrete or masonry structures. It is conceivable that this object could be achieved by measuring the relative humidity in the porous structure directly and calculating changes in the relative humidity from one measuring cycle to another, and the rate of the change in the relative humidity could be used to regulate the duration of the neutral pulse and/or the duration of the pulse pattern. However, this is an expensive solution, which would require separate equipment for measuring the relative humidity in addition to a costly installation of this equipment in the porous structure, which would also entail a physical intrusion into the porous structure.

A second object of the invention is therefore to simplify the measuring apparatus and permit the determination of a rational control criterion for the regulation without the use of an expensive, comprehensive apparatus and without the necessity of a physical intrusion into the porous structure.

According to the present invention the above-mentioned objects are achieved with a method which is characterized by the features which are presented in the characteristic of claim 1, and a device which is characterized by the features which are presented in the characteristic of claim 13.

The invention will now be described in more detail with reference to the accompanying drawing, in which

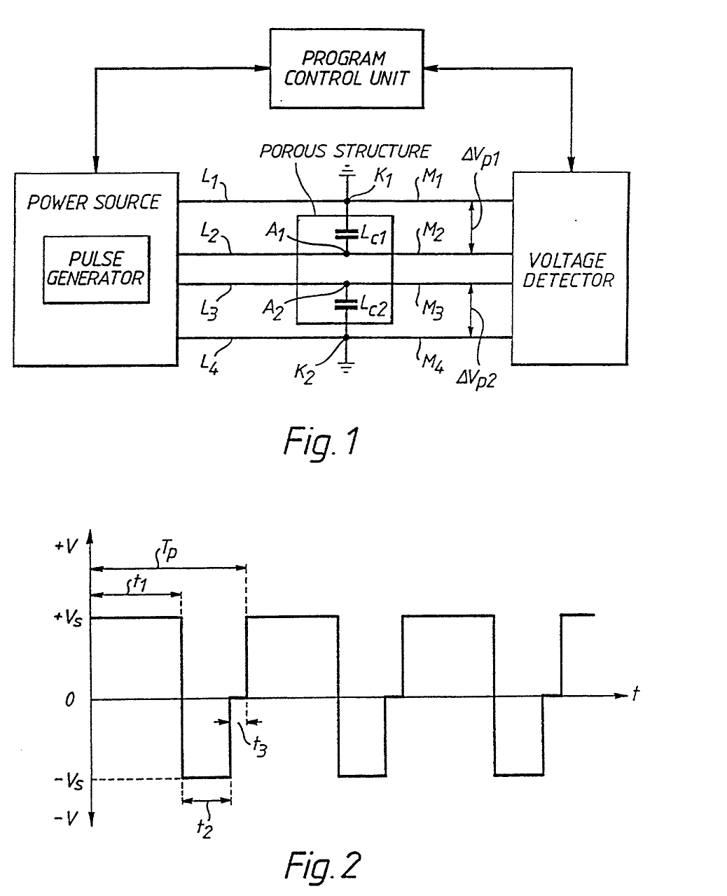

FIG. 1 illustrates a device for transport of liquid in porous structures by means of electroosmosis, and

FIG. 2 illustrates the pulse voltage employed in the electroosmosis in the form of a sequence of the pulse pattern.

FIG. 1 illustrates a device where there are employed in the porous structure two electrode pairs A₁, K₁; A₂, K₂, where A₁, A₂ indicate the anodes which are provided in the porous structure and K₁, K₂ the cathodes which are provided in earth. The electrode pairs are connected with respective outputs on a power source via the lines L₁, L₂; L₃, L₄ respectively, and the power source comprises a pulse generator for generation of the desired pulse pattern. Furthermore each of the electrode pairs are connected with a voltage detector via respective measuring lines M₁, M₂; M₃, M₄. In a loop between the voltage detector and the power source there is provided a program control unit. Via the pulse generator on the lines L₁, L₂; L₃, L₄ the power source supplies to the respective electrode pairs A₁, K₁; A₂, K₂ a pulse voltage consisting of a sequence of pulse patterns composed of a positive pulse with duration t₁, and voltage amplitude +Vₛ, followed by a negative pulse with duration t₂ and a voltage amplitude −Vₛ and then a neutral pulse with duration t₃, where t₂ is substantially less than t₁, with the result that the pulse pattern receives a positive voltage integral. Initially, i.e. at the start-up of the electroosmotic process, t₃ constitutes only a fraction of, e.g., t₂ and can advantageously be between 10 and 20 ms.

The voltage detector is now activated via the program control unit in a predetermined measuring cycle which is commensurable with the duration Tₚ of a pulse pattern and which, when the neutral interval t₃ occurs, triggers the voltage detector to measure any potential difference between the electrodes A, K in each electrode pair on the measuring lines M₁, M₂ and M₃, M₄ respectively. Since no working voltage ±Vₛ is applied from the power source via the electrodes A, K, during this interval the voltage detector will detect the electrodes' possible polarization state as a potential difference ΔVₚ, with, for example, ΔVₚ₁ the potential difference over the first electrode pair A₁, K₁ and ΔVₚ₂ the potential difference over the second electrode pair A₂, K₂.

On the basis of the detected potential difference ΔVₚ and a possible change in the detected potential difference ΔVₚ the program control unit now gives a control value to the power source's pulse generator which causes the duration t₃ of the neutral interval to be changed and possibly also the duration of the pulse pattern Tₚ. This can be performed on the basis of the ratio

$$\frac{Δ {V}_{p}}{{V}_{s}}$$

with the result that t and/or Tₚ are increased if an increase is detected in ΔVₚ. Similarly t₃ and/or Tₚ are kept constant if ΔVₚ is constant between each measurement or decreases.

Initially the duration Tₚ of the pulse pattern can be pre-programmed to lie in the interval 1-4 s. and depending on the measured potential difference Vₚ is regulated in such a manner that Tₚ becomes up to 20 s. As mentioned, initially the duration t₃ of the neutral pulse can be very short, 10-20 ms, which is more than sufficient to perform the detection of the potential difference ΔVₚ. By regulating t₃ in such a manner that it is increased by a detected potential difference ΔVₚ and in relation to the ratio

$$\begin{matrix}Δ {V}_{p} \\ Δ {V}_{s}\end{matrix} ,$$

an approximate optimal depolarization of the electrodes is achieved, since ΔVₚ will be reduced during the duration t₃ of the neutral pulse. Thus by regulating the duration of the neutral pulse t₃ an approximately complete depolarization of the electrodes can be achieved, with the result that the detected potential difference ΔVₚ will at all times constitute at the most an insignificant fraction of the working voltage Vₛ. The object is thereby achieved that the electroosmotic process becomes more efficient, since the polarization of the electrodes will otherwise reduce the efficiency of the process and could thereby cause it to come to a complete stop.

In the course of the process the regulation will ensure that both t₃ and Tₚ increase until the ionic transport phenomena in the liquid which has to be transported cease since the relative humidity in the porous structure drops below a given level, for example 75-70% relative humidity. The program control unit will then put the power source in a maintenance phase, wherein a very low-strength current and a pulse voltage are supplied to the electrodes while the duration of the pulse pattern can be approximately 5 times the initial duration Tₚ of the pulse pattern, in other words it will come to 5-20 s. Similarly the duration t₃ of the neutral pulse in this maintenance phase will be in the interval 1-8 s.

If the method according to the invention is employed, e.g., for drying masonry, the maintenance phase can be permanent and in this case a measuring cycle will be used for control of the electrodes' polarization state at very long intervals, e.g. from day to day or at intervals of several days.

When two electrode pairs have been provided, the program control unit can control the measuring cycles, the detection thus being performed in synchronous pulse patterns, but time-displaced in the interval t₃. By having the measurement of the potential difference ΔVₚ performed in time multiplex, only one detector is required, since the same detector is switched via the program control unit in time multiplex from electrode pair to electrode pair. Alternatively, the program control unit can switch the voltage detector to the first electrode pair A₁, K₁ in a first measuring cycle and subsequently the voltage detector to the second electrode pair A₂, K₂ in a subsequent measuring cycle, with the result that the voltage detector detects the potential differences ΔVₚ₁; ΔVₚ₂ in different measuring cycles, possibly following immediately one after the other.

At the same time the measuring cycle will be adjusted depending on the regulation of the pulse pattern via the pulse generator in the power source. The measuring cycle and the control power which cause the changes in the pulse pattern therefore form part of a control loop formed in the program control unit.

Even though the present invention is primarily described with a view to the use of electroosmosis for expelling humidity from porous structures, it should be understood that the method and device can be applied in the case of any porous structure where it is possible to cause electroosmotic processes, i.e. porous structures with capillaries. These are not limited to concrete and different kinds of masonry, but can include species of rock, minerals, earths and a great number of artificial materials. In this context, however, it is important to note that between the anode and the cathode in. an electrode pair there is a capacitive load during electroosmosis. This is also indicated in FIG. 1, where the load between each electrode pair A₁, K₁; A₂, K₂ is indicated in each case as a capacitive load or L_{c1} or L_{c2}.

1. A method for regulating and optimizing transport of liquid in a porous structure by means of electroosmosis, wherein there are employed one or more electrode pairs, wherein each electrode pair constitutes an electrical circuit comprising an anode in the porous structure and a cathode in earth, wherein the anode and the cathode are connected to respective outputs on a power source which supplies a pulse voltage to the electrode pair in the form of a sequence of pulse patterns, and wherein each pulse pattern comprises a first positive pulse with a given amplitude Vₛ and a duration t₂, a negative pulse with the same amplitude Vₛ, but substantially shorter duration t₂ than the positive pulse, and subsequently a neutral pulse whose duration t₃ is initially much less than the duration of the negative pulse and constitutes only a small fraction of the pulse pattern's duration Tₚ,
characterized by detecting any potential difference ΔVₚ over the anode and the cathode in at least one electrode pair during the duration t₃ of the neutral pulse in the pulse pattern which falls in the first measuring cycle, and, if ΔVₚ=0, depending on the ratio
$$\begin{matrix}Δ {V}_{p} \\ {V}_{s}\end{matrix} ,$$
regulating
a) the duration t₃ of the neutral pulse, or
b) the duration of pulse Tₚ of the pulse pattern, or
c) both the duration t₃ of the neutral pulse and the duration Tₚ of the pulse pattern,
whereupon the measuring cycle is repeated with a predetermined repetition frequency, since the duration t₃ of the neutral pulse or the duration Tₚ of the pulse pattern or both increase if the detected potential difference ΔVₚ increases from one measuring cycle to another, and is otherwise kept constant, with the result that the duration t₃ of the neutral pulse at a maximum will amount to approximately twice the initial duration t₂ of the negative pulse, and the duration Tₚ of the pulse pattern at the most 5-10 times the initial duration Tₚ of the pulse pattern, whereupon these final values for the duration t₃ of the neutral pulse and the duration Tₚ of the pulse pattern are used in a maintenance phase after the liquid transport has ceased.

2. A method according to claim 1,
characterized in that the duration t₂ of the negative pulse amounts to between 0.1 and 0.2 times the duration t₁ of the positive pulse.

3. A method according to claim 1,
characterized in that the duration t₃ of the neutral pulse initially lies between 10 ms and 20 ms.

4. A method according to claim 1,
characterized in that the duration Tₚ of the pulse pattern is regulated in the interval 1-20 s.

5. A method according to claim 1,
characterized in that the duration Tₚ of the pulse pattern is selected initially in the interval 14 s.

6. A method according to claim 1,
characterized in that the duration Tₚ of the pulse pattern in the maintenance phase is regulated in the interval 5-20 s.

7. A method according to claim 1,
characterized in that the duration of the neutral pulse in the maintenance phase is regulated in the interval 1-8 s.

8. A method according to claim 1,
characterized in that the measuring cycle's repetition rate is preselected to lie in a frequency range from the initial pulse pattern frequency to once every 24 hours.

9. A method according to claim 1 or 8, wherein more than one electrode pair is used,
characterized in that the pulse pattern for each electrode pair is regulated by detecting the potential difference ΔVₚ for each electrode pair in one and the same measuring cycle by means of time-multiplexed detection.

10. A method according to claim 1 or 8, wherein more than one electrode pair is used,
characterized in that the pulse pattern for each electrode pair is regulated by detecting the potential difference ΔVₚ in the neutral interval for each electrode pair in different measuring cycles.

11. A method according to any of the preceding claims,
characterized in that it is implemented via a program control unit connected to a voltage detector and the power source respectively.

12. A method according to claim 11,
characterized in that the measuring cycle is adjusted depending on the effected change in the pulse pattern via a control loop provided in the program control unit.

13. A device for implementing the method for regulating and optimizing transport of liquid in a porous structure by means of electroosmosis, wherein there are employed one or more electrode pairs, wherein each electrode pair constitutes an electrical circuit comprising an anode in the porous structure and a cathode in earth, wherein the anode and the cathode are connected to respective outputs on a power source which supplies a pulse voltage to the electrode pair in the form of a sequence of pulse patterns, and wherein each pulse pattern comprises a first positive pulse with a given amplitude Vₛ and a duration t₂, a negative pulse with the same amplitude Vₛ, but substantially shorter duration t₂ than the positive pulse, and subsequently a neutral pulse whose duration t₃ is initially much less than the duration of the negative pulse and constitutes only a small fraction of the pulse pattern's duration Tₚ, characterized in that one or more electrode pairs (A, K) are connected respectively in series via a voltage detector, that the voltage detector is connected to a program control unit, and that the program control unit is connected to a pulse generator provided in a power source, such that on the basis of a potential difference ΔVₚ over each electrode pair (A, K) and detected during the duration t₃ of the neutral pulse in a pulse pattern generated by the pulse generator, the program control unit regulates the pulse pattern supplied from the power source to the electrode pair or electrode pairs with regard to the duration t₃ of the neutral pulse or the duration Tₚ of the pulse pattern or both.
